(19) United States
(12) Patent Application Publication
(10) Pub. No.: US 2019/0181517 A1
(43) Pub. Date: Jun. 13, 2019

(54) BATTERY DEVICE FOR AN AT LEAST PARTIALLY ELECTRICALLY OPERATED MOTOR VEHICLE

(71) Applicant: Dr. Ing. h.c. F. Porsche Aktiengesellschaft, Stuttgart (DE)

(72) Inventors: Philipp Kellner, Rennigen (DE); Jens Bohlien, Stuttgart (DE)

(73) Assignee: Dr. Ing. h.c. F. Porsche Aktiengesellschaft, Stuttgart (DE)

(21) Appl. No.: 16/181,535

(22) Filed: Nov. 6, 2018

(30) Foreign Application Priority Data
Dec. 12, 2017 (DE) 102017129525.9

(51) Int. Cl. H01M 10/6568; H01M 2/10; H01M 10/613; H01M 10/625; B60L 11/18; B60K 1/04

(52) U.S. Cl. CPC H01M 10/6568; H01M 2/1077; H01M 10/613; H01M 10/625; H01M 2220/20; B60K 1/04; B60K 2001/0438; B60Y 2200/91; B60L 11/1879

(57) ABSTRACT

A battery device for an at least partially electrically operated motor vehicle and to a motor vehicle having such a battery device. The battery device comprises at least one battery module with a module housing device, which provides a receiving compartment for a plurality of battery cells and surrounds same in the manner of a housing and which comprises two housing end parts which dose a housing center part on the end sides. The module housing device is provided with a duct system for conducting a temperature control medium for controlling the temperature of the battery cells. Here, one of the housing end parts has at least one integrated first cooling duct. The first cooling duct can be fluidically connected to at least one second cooling duct integrated into the housing center part.

### CROSS-REFERENCE TO RELATED APP CATION

This application claims priority to German Patent Application No. DE 10 2017 129 525.9 filed Dec. 12, 2017, which is incorporated by reference herein in its entirety.

### FIELD OF THE INVENTION

The present invention relates to a battery device, in particular high-voltage energy accumulator, for an at least partially electrically operated motor vehicle. The battery device comprises at least one battery module with at least one module housing device which provides at least one receiving compartment for a plurality of battery cells and surrounds same in the manner of a housing. The module housing device is provided with at least one duct system for conducting at least one temperature control medium for controlling the temperature of the battery cells.

### BACKGROUND OF THE INVENTION

Reliable temperature management is generally of great importance for the operation and durability of the battery of an electric vehicle. Such batteries are frequently provided with a temperature control device which, for example, can cool or else heat the battery cells.

The prior art has, for example, disclosed batteries in which the battery cells are combined into groups to form battery modules. The battery modules are arranged along cooling ducts. However, expensive and complicated connection of the cooling ducts to the battery modules is frequently necessary. In addition, the cooling action of such an arrangement is capable of improvement.

Batteries in which the cooling ducts are arranged along the battery cells have therefore been disclosed. However, a large amount of construction space is required for this purpose. In addition, a significantly increased outlay on production and costs is frequently necessary.

### SUMMARY OF THE INVENTION

It is therefore the object of the present invention to provide a battery device for an at least partially electrically driven vehicle which permits an improved and preferably cost-effective temperature control of the battery cells that is optimized in terms of construction space and in terms of weight.

This object is achieved by a battery device having the features of claim 1 and by a motor vehicle as claimed in claim 15. Preferred developments are the subject matter of the dependent claims. Further advantages and features of the present invention will emerge from the general description and from the description of the exemplary embodiment.

The battery device according to aspects of the invention is designed in particular as a high-voltage energy accumulator. The battery device is in particular suitable and designed for an at least partially electrically operated vehicle. The battery device comprises at least one battery module with at least one module housing device which provides at least one receiving compartment for a plurality of battery cells and surrounds same in the manner of a housing. The module housing device comprises at least two housing end parts which close at least one housing center part on its end sides. The module housing device is provided with at least one duct system for conducting at least one temperature control medium for controlling the temperature of the battery cells. Here, at least one of the at least two housing end parts has at least one at least partially integrated first cooling duct. The first cooling duct can be fluidically connected to at least one second cooling duct which is at least partially integrated into the housing center part.

The battery device according to aspects of the invention affords numerous advantages. A considerable advantage is afforded by the embodiment according to aspects of the invention of the housing end part, which results in a particularly advantageous integration of functions. Thus, the housing end part can perform the housing function on the one hand and a particularly effective cooling function on the other hand. It is thereby possible to make considerable savings in terms of weight and construction space and in terms of production outlay or production costs.

In an operationally mounted state of the battery device, the at least one first cooling duct is in particular fluidically connected to the at least one second cooling duct.

The housing end part preferably has at least one interface for coupling the duct system to at least one supply line extending outside of the battery module. The interface can preferably be fluidically connected to the first cooling duct. Such an embodiment means that a further function can be integrated into the housing end part. In particular, only one of the at least two housing end parts is designed in such a way. The supply line can be designed for example as a main cooling line or at least comprise such a line. The supply line can also be designed as a connection or as a collector for two or more battery modules or at least comprise such a connection or collector.

The first cooling duct preferably has a course which is suitable and designed to deflect the temperature control medium within the housing end part. For example, the first cooling duct comprises at least one curve and/or loop and/or angled-off portion. In particular, such a course is incorporated into the housing end part.

With particular preference, the first cooling duct is provided by means of at least one milled clearance and/or bore in the housing end part. Here, the housing end part is preferably formed in one piece and/or as a solid component into which the cooling duct is milled and/or bored. This makes possible a particularly uncomplicated production of the cooling duct. It is also possible and preferable or the first cooling duct to be produced by at least one joining of at least two components and/or by means of additive manufacture. This also affords a very uncomplicated and economic production of the cooling duct or of the housing end part.

In an advantageous embodiment, at least one portion of the first cooling duct is dosed in a fluid-tight manner by at least one closure element and in particular by at least one plug. Such an embodiment means that the production of the cooling duct can be considerably simplified. In particular, the plug is fastened in the housing end part and for example screwed and/or adhesively bonded and/or welded or the like. For example, the milled clearance and/or bore in the housing end part is closed in certain portions in this way. In particular, at least one branching and/or at least one duct arm of the first cooling duct is closed by the closure element. Other suitable means for fluid-tight closing of the cooling duct are also possible.

In a likewise advantageous embodiment, the housing end part is formed from at least two components or it comprises at least two components. The at least two components preferably together surround the first cooling duct. In particular, the first cooling duct extends at least in certain portions between the at least two components. Three or more components are also possible. The components can be connected to one another so as to be releasable or else permanently fixed.

At least one component can have at least one duct-like depression which is closed by the other component to provide at least one portion of the first cooling duct. It is also possible for both components to each have at least one depression. Here, the depressions together provide the cooling duct and surround same.

In particular, the housing end part is formed in one piece with the first cooling duct. Such an embodiment can be implemented for example by milled-out clearances or bores in the housing end part. The housing end part and the first cooling duct can also be provided by separate components. In an operationally mounted state, the separate components can be connected to one another so as to be releasable or else fixed or nonreleasable. The housing end part is in particular formed as a single part. The housing end part can also be of multipart design.

The housing center part can be formed as a single part or be, of multipart design. In particular, the housing center part is formed in one piece with the second cooling duct. The housing center part and the second cooling duct can also be provided by separate components.

It is possible and preferred for the housing, center part to bound the receiving compartment on at least two sides and preferably on at least four sides. The housing center part particularly preferably surrounds the receiving compartment on the longitudinal sides and in particular in a tubular manner.

In particular, the housing center part is at least partially composed of at least one profile component, which is extruded and/or is produced in a continuous manufacturing process, or comprises at least one such profile component. The profile component in particular has two open end sides which are closed by a respective housing end part.

In order to seal the housing end part with respect to the housing center part, the housing end part is preferably screwed and/or welded and/or adhesively bonded to and/or pressed with the housing center part. It is possible and preferred also for at least one plastic or elastic sealing device to be arranged between the housing end part and the housing center part. Another suitable sealing device is also possible. In particular, the housing center part and the housing end part are connected to one another in such a way that the first and the second cooling duct are connected to one another in a fluid-tight manner. This makes possible a particularly uncomplicated and economic production of the battery device.

In a particularly advantageous embodiment, the first cooling duct branches at least once, with the result that the first cooling duct can be fluidically connected to second cooling ducts arranged on opposite sides of the housing center part. In particular, for this purpose, the housing center part comprises second cooling ducts on at least two different and in particular opposite sides. Thus, components and weight can be saved. The branched first cooling duct is in particular connected to the interface for coupling the supply line. With particular preference, the first cooling duct has at least one continuous duct arm which connects the second cooling ducts on the opposite sides. Here, the first cooling duct preferably has a further duct arm which is connected to the interface for coupling the supply line.

The first cooling duct preferably extends at least in certain portions and in particular completely within the housing end part. In particular, the first cooling duct is surrounded by the housing end part. The first cooling duct is in particular suited and designed to forward and/or deflect and/or bring together and/or separate the temperature control medium within the housing end part. It is possible that the first cooling duct extends within the housing end part at least in certain portions transversely to the, longitudinal direction of the housing center part and/or parallel to a main plane of the housing end part.

The second cooling duct preferably extends at least in certain portions and in particular completely within at least one wail of the housing center part. In particular; the second cooling duct is at least partially and in particular completely surrounded by the wall.

It is possible and preferred for the second cooling duct to extend at least in certain portions in one or in both side walls of the housing center part. The housing center part comprises in particular two opposite side walls. It is possible and preferred also that the second cooling duct extends at least in certain portions in an upper and/or lower wall of the housing center part.

In particular, the housing end part has at least one first cooling duct designed as a supply duct and/or at least one first cooling duct designed as a return duct. In particular; the supply duct and the return duct are equipped with in each case at least one interface for coupling a supply line. In particular, the supply duct and the return duct are designed for the connection of second cooling ducts which are arranged on opposite sides of the housing center part. For this purpose, the supply duct and the return duct are preferably equipped with at least one branching in each case. The branching sets up in particular at least one duct arm connected to the interface and at least one duct arm connecting the second cooling ducts.

In a preferred embodiment, the housing end part comprises one supply duct and two return ducts. Here, the return duct is preferably arranged on the outside. The supply duct is in particular arranged therebetween or centrally. Other arrangements are also possible.

It is possible and preferred that only one of the at least two housing end parts has an integrated first cooling duct which can be fluidically connected to the second cooling duct. It is also possible that the at least two housing end parts each have at least one at least partially integrated cooling duct which can be fluidically connected to the second cooling duct. Here, the first cooling duct of a second housing end part is preferably at least partially designed such as has been previously described for the housing end part. In particular, each of the above-described embodiments for the at least one housing end part can also be provided on the at least one other or second housing end part.

At least two or three or a plurality of first and/or second cooling ducts can also be provided. It is possible that a first cooling duct can be fluidically connected to two or more second cooling ducts, or vice versa. The first and the second cooling duct are in particular part of the duct system.

In particular, in each case one housing end part in each case closes an end side of the housing center part. In particular, at least two separate housing end parts are provided. The housing end parts can be connected directly or indirectly to the housing center part. In particular, one of the at least two housing end parts is suited and designed such that the second cooling duct arranged in the housing center part is closed in a fluid-tight manner in certain portions.

In all of the embodiments, it is preferred for water and/or a water-glycol mixture and/or an evaporable refrigerant and/or oil to be provided as the temperature control medium. Another suitable temperature control medium is also possible. The temperature control medium is in particular a fluid.

The motor vehicle according to aspects of the invention is provided with an at least partially electrically operated traction drive. The motor vehicle comprises at least one battery device, as has previously been described or the energy supply of the traction drive.

The motor vehicle according to aspects of the invention has numerous advantages and can be produced, for example, in a particularly economical and uncomplicated manner. In addition, it provides an optimized overall weight. The motor vehicle is designed in particular as a passenger motor vehicle.

Within the scope of the present invention, a module housing device is preferably understood not as meaning a housing for the entire battery or for the entirety of all the battery cells, but rather a housing for a group of battery cells which are combined to form a battery module.

The battery cells of the battery device are combined in, particular into groups to form battery modules. The battery modules in particular are connected electrically to one another and are preferably also connected in terms of flow with respect to the temperature control medium. The battery device preferably comprises a plurality of battery modules. The battery device can also comprise just one battery module.

The battery device comprises in particular at least one receiving device for the at least one battery module and preferably for a plurality of battery modules. The receiving device is designed, for example, as a housing or the like. The battery modules can be accommodated in particular together with their module housing devices in the receiving device.

The module housing device is designed in particular as an outer housing. In particular, the module housing device encloses the receiving compartment and the battery cells accommodated therein and in particular also further components which are accommodated therein. In particular, the module housing device at least partially, and in particular completely, delimits the receiving compartment to the outside. Here, connections and/or accesses can be provided.

Within the scope of the present invention the term cooling is preferably used within the context of temperature control, and therefore it is also understood as meaning warming up or heating.

The duct system is in particular part of at least one temperature control device The temperature control device can comprise at least one conveying device for conveying the temperature control medium, and/or at least one heat exchanger and/or other components provided for the temperature control.

### BRIEF DESCRIPTION OF THE DRAWINGS

Further advantages and features of the present invention will emerge from the exemplary embodiment, which will be discussed below with reference to the appended figures.

FIG. 1 is a highly schematic illustration of a battery device according to aspects of the invention in a motor vehicle;

FIG. 2 is a schematic illustration of a module housing device battery device in a partially transparent perspective exploded illustration;

FIG. 3 is a schematic illustration of a module device in a sectioned top view;

FIG. 4 is a schematic illustration of a further module housing device of a battery device in a partially transparent perspective illustration;

FIG. 5 is a schematic illustration of a battery device in a top view and of the module housing device prior to a machining operation in a sectioned perspective view;

FIG. 6 is a schematic detail illustration of the battery device of FIG. 5 in a sectioned top view.

### DETAILED DESCRIPTION OF THE INVENTION

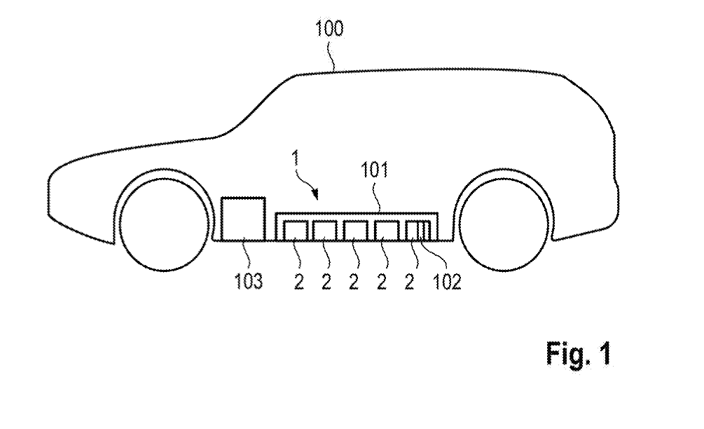

FIG. 1 shows a motor vehicle 100 or passenger motor vehicle which is designed as an electric vehicle. The vehicle 100 can also be designed as a hybrid vehicle. The motor vehicle 100 is equipped with a battery device 1 according to aspects of the invention which serves as a high-voltage energy accumulator 101 for an electric traction drive 103. The battery device 1 is accommodated here by way of example in a floor region of the motor vehicle 100. The battery device 1 may, however, also be arranged at another location in the motor vehicle 100.

The battery device 1 comprises a plurality, of battery modules 2 which each have a plurality of, or a functional group of, battery cells 102. More or fewer battery modules 2 than shown here may also be provided. For better clarity, only one battery cell 102 is shown here by way of example.

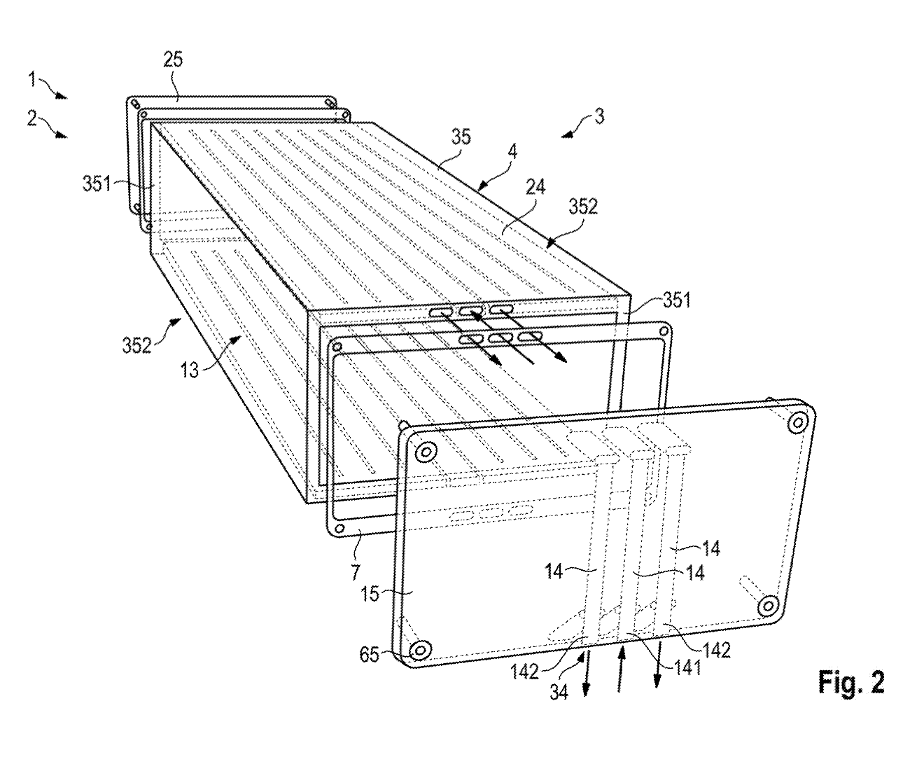

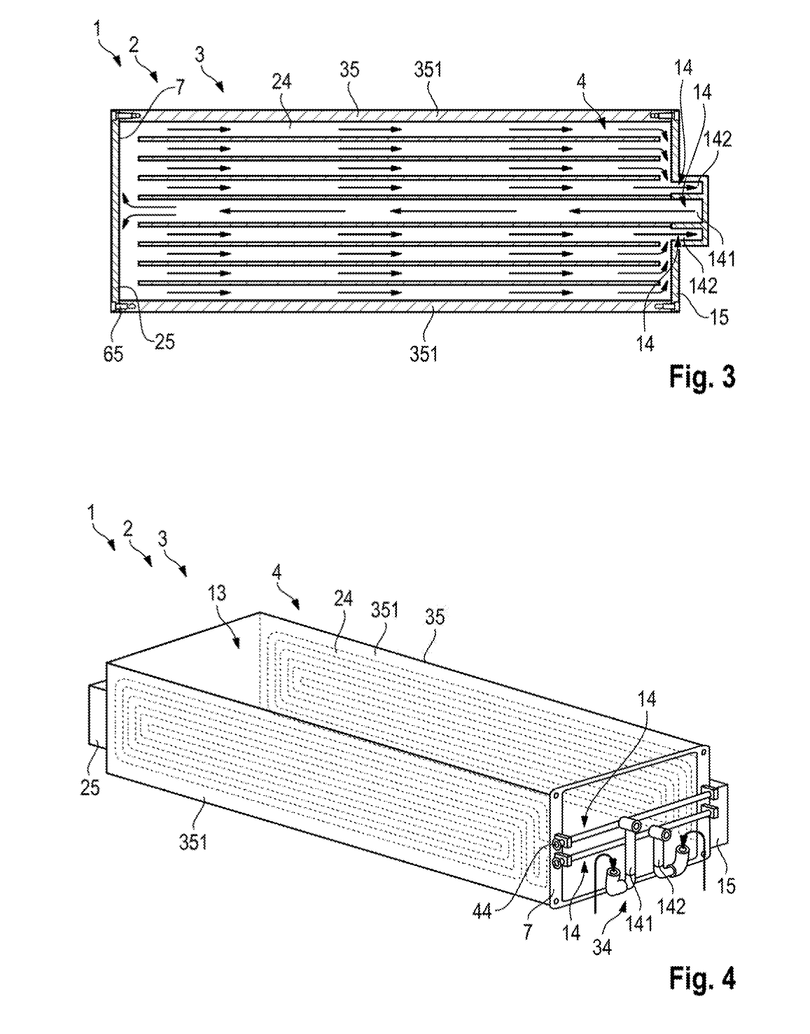

FIGS. 2 and 3 show a battery device 1 according to aspects of the invention in a perspective exploded illustration and in a sectioned illustration, respectively.

The battery cells 102 associated with the battery module 2 are enclosed here in a module housing device 3. The module housing device 3 provides a receiving compartment 13 for the cells 102.

The module housing device 3 here comprises two housing end parts 15, 25 which each close an end side of a housing center part 35. The housing center part 35 surrounds the receiving compartment 13 or the battery cells 102 on the longitudinal sides and in a tubular manner. The housing center part 35 here has two opposite side walls 351 and an upper wall 352 and a lower wall 352.

The battery device 1 is equipped with a temperature control device for controlling the temperature of the battery cells 102. For this purpose, a duct system 4 is provided through which a temperature control medium is conducted. The duct system 4 here comprises a plurality of first and second cooling ducts 14, 34 through which the temperature control medium can flow. The flow directions are indicated here by corresponding arrows.

The second cooling ducts 24 are integrated into the housing center part 35 and extend within the walls 352. However, the cooling ducts 24 can also be arranged only in the upper or the lower wall 352. Alternatively or in addition, the cooling ducts 24 can also be integrated in one or in both side walls 351.

The first cooling ducts 14 here are integrated into the front housing end part 16. The first cooling ducts 14 can be fluidicallly connected to the second cooling ducts 24. The connection is established here by the operational mounting of the housing end part 15 on the housing center part 35.

In order to fasten and seal the housing end part 15 with respect to the housing, center part 35, screw connections 65 are provided here. Welding and/or adhesive bonding and/or pressing is also possible. Moreover, in the embodiment shown here, a plastic or elastic sealing device 7 is arranged between the housing end part 15 and the housing center part 35.

The other or rear housing end part 25 is here likewise screwed in a sealing manner to the housing center part 35. Moreover, a sealing device 7 is also provided.

The housing end part 15 here comprises three first cooling ducts 14 which each have a branching. There is thus obtained for each cooling duct 14 a duct arm which fluidically connects the second cooling ducts 24 on the upper side of the housing center part 35 to the second cooling ducts 24 on the lower side. For this purpose, the first cooling ducts 14 here have courses which deflect the temperature control medium within the housing end part 15.

Moreover, the branchings each provide a duct arm which is here connected to an interface 34. The interface 34 serves for coupling the duct system 4 to supply lines 104 which are not represented in more detail here.

The housing end part 15 shown here comprises two first cooling ducts 14 which are designed as return ducts 142. One cooling duct 14 is here designed as a supply duct 141. In this case, the supply duct 141 is here arranged between the return ducts 142.

The return ducts 142 and the supply duct 141 are equipped with an interface 34 in each case in order to be coupled to a corresponding supply line for supply or return. Both the return ducts 142 and the supply duct 141 connect the second cooling ducts 24 of the housing center part 35 which are situated on different sides. The temperature control medium can thus flow both to the upper and to the lower second cooling ducts 24.

FIG. 4 shows a battery module 2 with a module housing device 3 in which the second cooling ducts 24 extend in the housing center part 35 within the side walls 351. For this purpose, the housing end part 15 is adapted such that its first cooling ducts 14 can be fluidically connected to the second cooling ducts 24. The flow directions are indicated here by corresponding arrows.

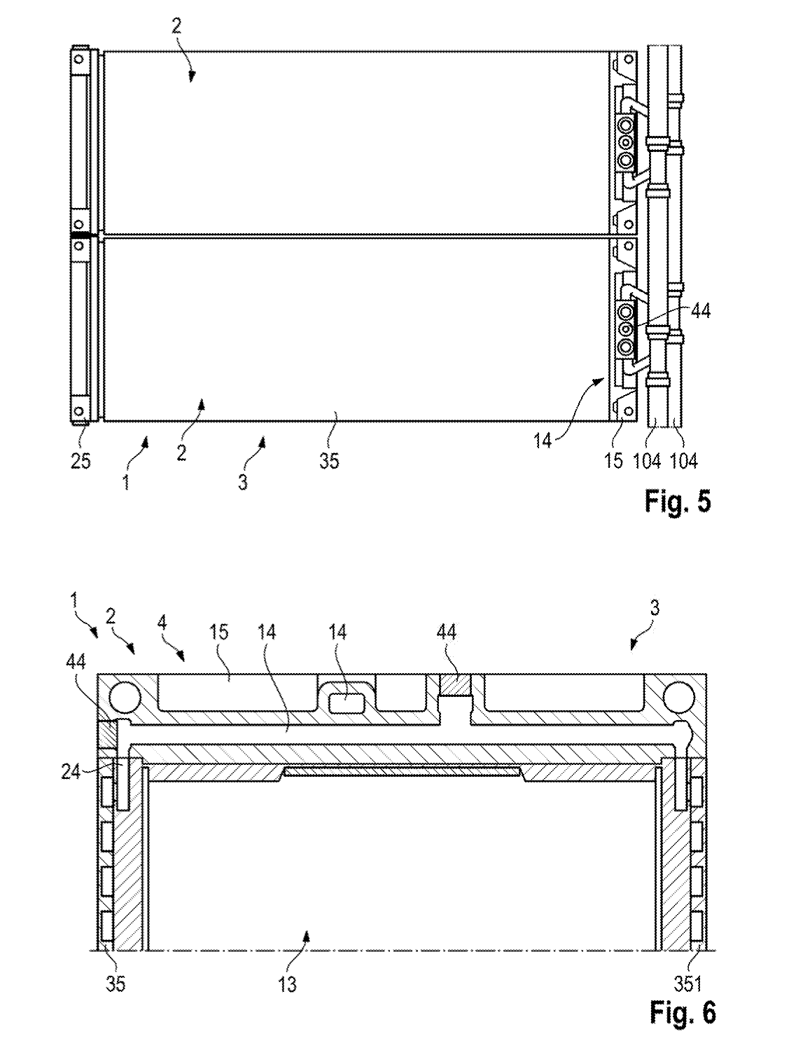

The embodiment of the housing end part 15 that here is illustrated in more detail in FIGS. 5 and 6.

FIG. 5 shows the respective supply lines 104 for supply or return. In order to illustrate the connection scheme, FIG. 5 shows two battery modules 2 which are arranged next to one another and which are equipped with a module housing device 3 in each case.

The housing end part shown in FIGS. 4 to 6 is equipped with first cooling ducts 14 which are at least partially incorporated into the housing end part 15 by way of bores and/or milled clearances. Some portions of the cooling ducts 14 are closed in a fluid-tight manner by closure elements 44, for example plugs. The closed portions are required in particular on account of the production process and, for example, on account of bores.

The section plane shown in FIG. 6 reveals a duct arm of the first cooling duct 14 that extends transversely to the side walls 351 of the housing center part 35. This duct arm connects the second cooling ducts 24 which are arranged on the opposite side walls 351.

Moreover, the section plane shown also reveals a further duct arm which extends transversely to the above-described duct arm. This duct arm connects the cooling duct 14, for example, to an interface 34 which is not visible here.

The invention presented here provides a module housing device 3, in which the temperature control medium and the cooling ducts 14 are integrated directly in the housing. The cooling efficiency can thus be significantly improved. For example, particularly low thermal resistance between temperature control medium and battery cells 102 thereby arises.

Cost savings because of the integration of functions or reduction in the number of parts are a further advantage. Separate cooling lines which would have to be thermally connected to the battery module, for example by means of expensive heat-conducting pastes, can thereby be omitted.

Overall, the invention provides a considerable improvement in the cooling efficiency. In addition, a considerable weight reduction and a significant cost reduction and also a considerably lower requirement for construction space are achieved.

### LIST OF REFERENCE DESIGNATIONS

1 Battery device

2 Battery module

3 Module housing d e

4 Duct system

7 Sealing device

13 Receiving compartment

14 Cooling duct

15 Housing end part

24 Cooling duct

25 Housing end part

34 Interface

35 Housing center part

44 Closure element

65 Screw connection

100 Motor vehicle

101 High-voltage energy accumulator

102 Battery cell

103 Traction drive

104 Supply line

141 Supply duct

142 Return duct

351 Side wall

352 Wall

What is claimed is:

1. A battery device for an at least partially electrically operated motor vehicle, the battery device comprising:
at least one battery module including:
a module housing device which provides at least one receiving compartment for a plurality of battery cells and surrounds the plurality of battery cells; and
at least two housing end parts which close at least one housing center part on the end sides, wherein the module housing device is provided with at least one duct system for conducting at least one temperature control medium for controlling the temperature of the battery cells, wherein at least one of the at least two housing end parts has at least one at least partially integrated first cooling duct, and in that first cooling duct can be fluidically connected to at least one second cooling duct which is at least partially integrated into the housing center part.

2. The battery device as claimed in claim 1, wherein the housing end part has at least one interface for coupling the duct system to at least one supply line extending outside of the battery module and wherein the interface is fluidically connected to the first cooling duct.

3. The battery device as claimed in claim 1, wherein the first cooling duct has a course which is configured to deflect the temperature control medium within the housing end part.

4. The battery device as claimed in claim 1, wherein the first cooling duct is provided by at least one milled clearance and/or bore in the housing end part and/or wherein the first cooling duct is produced by at least one joining of at least two components and/or by means of additive manufacture.

5. The battery device as claimed in claim 1, wherein at least one portion of the first cooling duct is dosed in a fluid-tight manner by at least one closure element.

6. The battery device as claims is claim 5, wherein one or more of the at least one closure element is at least one plug.

7. The battery device as claimed in claim 1, wherein the housing end part is formed from at least two components and wherein the at least two components together surround the first cooling duct.

8. The battery device as claimed in claim 7, wherein at least one component has at least one duct-like depression which is closed by the other component to provide at least one portion of the first cooling duct.

9. The battery device as claimed in claim 1, wherein the housing end part is formed in one piece with the first cooling duct.

10. The battery device as claimed in claim 1, wherein, in order to seal the housing end part with respect to the housing center part, the housing end part is at least one of screwed, welded, adhesively bonded to, or pressed with the housing center part, and/or wherein at least one plastic or elastic sealing device is arranged between the housing end part and the housing center part.

11. The battery device as claimed in claim 1, wherein the first cooling duct branches at least once, with the result that the first cooling duct is fluidically connected to second cooling ducts which are arranged on opposite sides of the housing center part.

12. The battery device as claimed in claim 1, wherein the first cooling duct extends at least in portions within the housing end part and/or wherein the second cooling duct extends at least in portions within at least one wall of the housing center part.

13. The battery device as claimed in claim 1, wherein the second cooling duct extends at least in portions in one or in both side walls of the housing center part and/or wherein the second cooling duct extends at least in portions in an upper and/or lower wall of the housing center part.

14. The battery device as claimed in claim 1, wherein the housing end part has at least one first cooling duct configured as a supply duct and at least one first cooling duct configured as a return duct and wherein the supply duct and the return duct are each at least one of equipped with at least one interface for coupling a supply line or configured for the connection of second cooling ducts which are arranged on opposite sides of the housing center part.

15. The battery device as claimed in claim 1, wherein at least one of water, water-glycol mixture, evaporable refrigerant, or oil is provided as the temperature control medium.

16. The battery device as claimed in claim 1, wherein the battery device is a high-voltage energy accumulator

17. A motor vehicle with an at least partially electrically operated traction drive, comprising a battery device as claimed in claim 1, for the energy supply of the traction drive.
